(19) United States
(12) Patent Application Publication
(10) Pub. No.: US 2007/0124237 A1
(43) Pub. Date: May 31, 2007

(54) System and method for optimizing cross-sell decisions for financial products

(75) Inventors: Ramasubramanian Gangaikondan Sundararajan, Bangalore (IN); Puthugramam Gopala Krishnan, Bangalore (IN); Babu Ozhur Narayanan, Banglore (IN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/289,911

(22) Filed: Nov. 30, 2005

(51) Int. Cl. G06Q 40/00

(52) U.S. Cl. 705/38

(57) ABSTRACT

A method for selecting a target list of customers for making cross sell offers to, for a financial product is provided. The method includes obtaining customer-level information related to one or more members from a historical database. The method then includes building one or more response models and one or more profit models for one or more subsets of members, using the customer-level information. Then, the method includes generating one or more response scores and one or more profit scores for one or more members from a target population, using the one or more response models and the one or more profit models. Finally, the method includes determining a target list of customers for making cross-sell offers to, based on the one or more response scores and the one or more profit scores using an optimization methodology.

### BACKGROUND

The invention relates generally to customer relationship management (CRM) and more particularly to a system and method for optimizing cross-sell decisions for financial products.

Financial institutions generally offer a portfolio of financial products, such as loans, credit cards and insurance policies to its customers. A financial institution typically contains a database of information pertaining to the history of each customer's relationship with the financial institution. This information may generally include socio-demographic information, customer account history information and customer transactional information related to various products that have been offered to the customer.

There are a number of distinct analytical processes that finance organizations routinely undertake. Of major importance is the “response scoring” process in which customers are scored according to their propensity to respond to marketing/CRM initiatives by the organization (such as credit offers or cross-sell initiatives), and the “profit scoring” process in which customers are scored according to their profit potential, either arising from a CRM initiative or from existing products held by the customer. As will be appreciated by those skilled in the art, the response and profit scoring processes may be based on several factors, such as the customer's credit risk profile, his/her income, past borrowing and repayment behavior, the offered product and the credit policies of the finance organization. Also of significant value is the computation of “risk scores” which score the customer according to his/her propensity to default on existing/future financial obligations with the organization.

Existing techniques for making cross-sell offers to customers are based on determining the response propensity of a customer to a given cross-sell offer, the profit potential derived from the customer for a given response, customer credit behavior and socio-demographic information etc. However, the response propensity and the profit potential determined by existing cross-sell techniques are generally based on point estimates of customer response propensity and customer profit potential and do not take into consideration, the customer-level forecast variability in estimating profit potential for a given response to a cross-sell offer.

It would be desirable to develop a technique for making cross-sell offers to customers, in which the inherent variability of these point estimates are incorporated into the process of determining the response propensity and profit potential for a set of customers. In addition, it would also be desirable to develop a method and system for determining a target list of customers for making cross sell offers to, that leverages multiple forecasts of customer-level profit potential for a given response to a cross-sell offer.

### BRIEF DESCRIPTION

Embodiments of the present invention address this and other needs. In one embodiment a method for selecting a target list of customers for making cross sell offers to, for a financial product is provided. The method includes obtaining customer-level information related to one or more members from a historical database. The method then includes building one or more response models and one or more profit models for one or more subsets of members, using the customer-level information. Then, the method includes generating one or more response scores and one or more profit scores for one or more members from a target population, using the one or more response models and the one or more profit models. Finally, the method includes determining a target list of customers for making cross-sell offers to, based on the one or more response scores and the one or more profit scores.

In another embodiment, a system for selecting a target list of customers for making cross sell offers to, for a financial product is provided. The system includes a model-building component and a scoring component. The model-building component is configured to build one or more response models and one or more profit models for one or more subsets of members selected from a model-building population. The scoring component is configured to generate one or more response scores and one or more profit scores for one or more members from a target population, using the one or more response models and the one or more profit models. The system further includes an optimization component. The optimization component is configured to determine a target list of customers, for making cross-sell offers to, based on the one or more response scores and the one or more profit scores.

### DRAWINGS

These and other features, aspects, and advantages of the present invention will become better understood when the following detailed description is read with reference to the accompanying drawings in which like characters represent like parts throughout the drawings, wherein:

FIG. 1 is an illustration of a high-level system for selecting a target list of customers for making cross sell offers to, for a financial product, in accordance with one embodiment of the present invention;

FIG. 2 is an exemplary illustration of a graph representing the distribution of profit scores for two customers;

FIG. 3 is an exemplary illustration of a graph representing the distribution of response scores for two customers;

FIG. 4 is a graph illustrating an aggregate expected return and an aggregate risk associated with the acceptance to a cross-sell offer, for one or more subsets of members from a target population; and

FIG. 5 is a flowchart of exemplary logic, including exemplary steps for selecting a target list of customers for making cross sell offers to, for a financial product.

### DETAILED DESCRIPTION

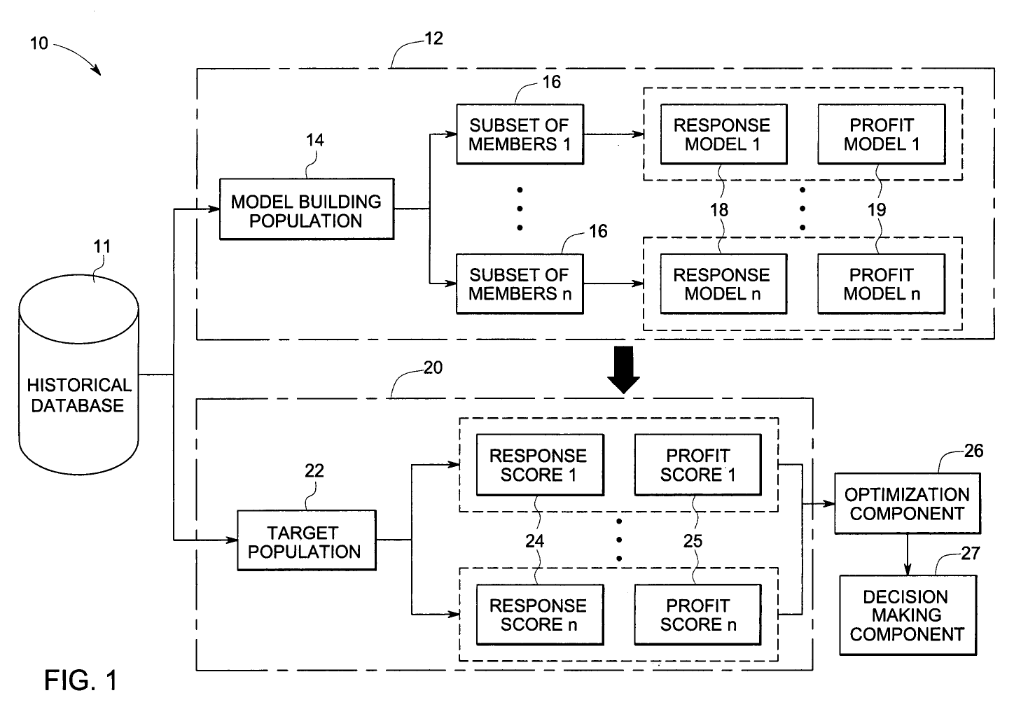

FIG. 1 is an illustration of a high-level system for selecting a target list of customers for making cross sell offers to, for a financial product, in accordance with one embodiment of the present invention. In one embodiment, the financial product includes a financial loan. In an alternate embodiment, the financial product may also include a credit card or an insurance policy. Referring to FIG. 1, the system 10 generally includes a historical database 11, a model-building component 12, a scoring component 20 and an optimization component 26. The historical database 11 includes customer-level information related to the history of each customer's relationship with a financial organization. Customer-level information may include demographic data, transaction level data and account level data related to customers. The transaction level data may include data pertaining to transaction events such as debits; credits as well as failure events like missed repayments on a customer's account through any channel. Account level data may include customer account information on previously subscribed financial products. Customer-level information may also include information about a customer's job profile and his/her position held in the job, his/her credit history, the number of years of residence of the customer at his/her current address, his/her income statement, the bank accounts and the life insurance policies of the customer, the loan repayment history of the customer and information related to past marketing campaigns of which the customer was a part of.

The model-building component 12 generates a model-building population 14 comprising one or more subsets of members 16, using the customer-level information in the historical database 11. In particular, the model-building component 12 builds one or more response models 18 and one or more profit models 19 for the one or more subsets of members 16. In accordance with one embodiment, the response models 18 represent the propensity of response of a member to a given cross-sell offer and the profit models 19 represent a prediction of profitability obtained by a member in response to a given cross-sell offer. As used herein, the “one or more subsets of members 16” refer to subsets of random samples of members selected from the model building population 14 by the model-building component 12. In one embodiment, a re-sampling technique may be applied by the model-building component 12 to randomly select the subsets of members 16. In a particular embodiment, the re-sampling technique may be based on randomly picking a customer with replacement from the set of available customers in the model building population, and repeating this process a number of times to arrive at a resample that may include repeated instances of the same customer. The size of the resample may be the same as the size of the original sample. Further, a variety of modeling techniques may be applied by the model-building component 12 to build the response models 18 and the profit models 19 for each of the one or more subsets of members 16. The modeling techniques may include, but are not limited to regression modeling techniques and neural network modeling techniques. As will be appreciated by those skilled in the art, the one or more profit models 19 generated using multiple modeling techniques, determine multiple forecasts of profit potential for a member comprising the subsets of members 16. Therefore, in accordance with embodiments of the present invention, the generation of random subsets of members through repeated re-sampling of data and the use of multiple profit models to generate multiple forecasts of profit potential for a member, resolves the inherent variability obtained from a single model forecast of profit potential for a member, by taking into consideration customer-level forecast variability in estimating the profit potential for a member.

A scoring component 20 generates one or more response scores 24 and one or more profit scores 25 for one or more members of a target population 22, using the response models 18 and the profit models 19 generated by the model-building component 12. In one embodiment, the “target population” includes a set of members eligible to be offered a financial product, in a given cross-sell campaign. The response scores 24 are a measure of a propensity of response by a member from the target population 22, to a given cross-sell offer. As used herein, the “propensity of response” refers to the probability of expected use of a financial product by a member from the target population 22. The profit scores 25 are a measure of the profit potential obtained by a member of the target population 22, to a given response to a cross-sell offer. A number of techniques are known in the art and may be used to determine the profit potential of a customer. Some of these techniques include determining ordinal “class” values, as well as actual profit numbers representing net inflows that take into account certain revenues and costs that can be apportioned at a customer level, as well as some risks associated with obtaining the revenues.

In a particular embodiment, the scoring component 20 generates one or more profit scores 25 for each member from the target population 22. From the profit scores 25, an expected return and a corresponding risk associated with an acceptance to a cross-sell offer, by a member from the target population is determined. As used herein, the “expected return” refers to the expected level of profitability associated with the acceptance to a cross-sell offer by a member from the target population and the “risk” refers to the variance in the profit potential. In a more particular embodiment, the profit scores 25, represent a set of risk adjusted contributed values (RACV) for each member from the target population.

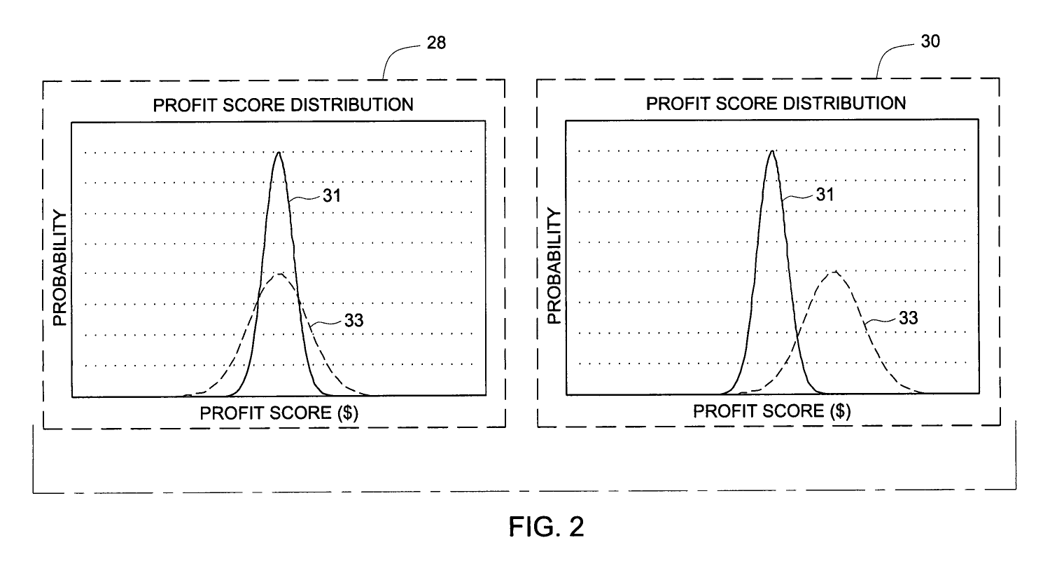

FIG. 2 is an exemplary illustration of a graph representing the distribution of profit scores for two members/customers from the target population. Also shown in FIG. 2 is a graph of the trade-off between the expected return and the corresponding risk associated with a given cross sell offer, for the two members. As may be observed from graph 28 illustrated in FIG. 2, customer 1, (referenced by the reference numeral 31), is a preferred customer over customer 2 (referenced by the reference numeral 33) since there is less uncertainty or variance (risk) about the expected return (represented by the mean of the distribution) from customer 1, as compared to customer 2. Graph 30 illustrates the trade-off between the expected return and the risk for both customer 1 and customer 2. As indicated by graph 30, customer 2 has a higher expected return than customer 1, but also has a higher degree of risk or variability than customer 1.

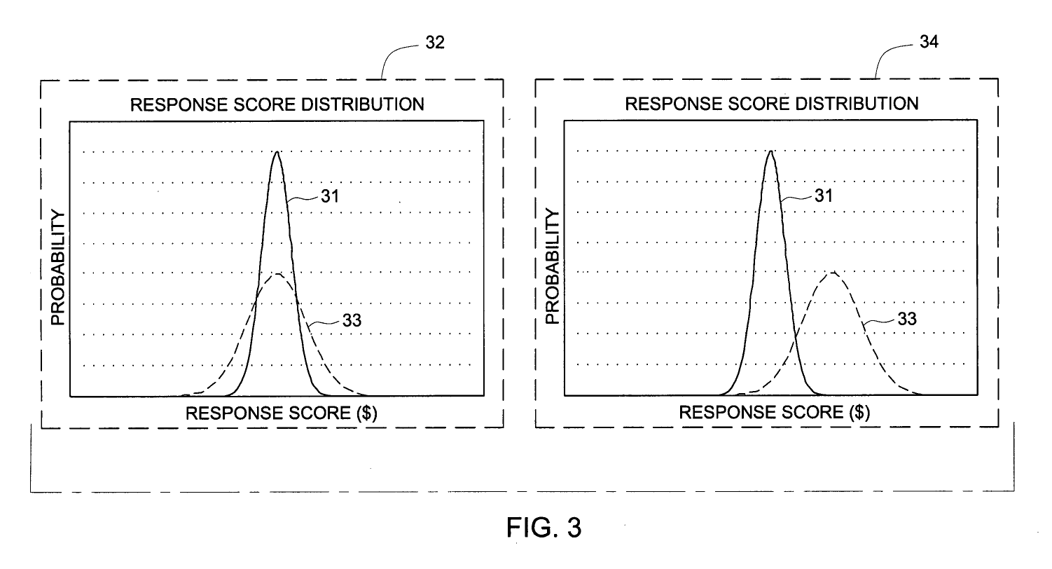

FIG. 3 is an exemplary illustration of a graph 32 representing the distribution of response scores for two members/customers from the target population. Also shown in FIG. 3, is a graph 34 of the trade-off between the expected response propensity and the corresponding risk associated with a given cross-sell offer for the two customers, 31 and 33.

Referring to FIG. 1 again, an optimization component 26 is configured to determine one or more subsets of members from the target population for making cross-sell offers to, based on the response scores and the profit scores generated for each member, by the scoring component 20. In a particular embodiment, the optimization component 26 is configured to determine an optimal set of solutions, wherein each solution represents a subset of members from the target population having a maximum aggregate expected return and a minimum aggregate risk. As will be appreciated by those skilled in the art, there may exist a number of subsets of members determined by the optimization component 26, which do not “dominate” each other. In other words, one subset of members may provide a higher expected return than another subset, but may also have a greater variability/risk associated with the expected return. As will be described in greater detail below, the optimization component 26 arrives at a set of “non-dominated solutions”, from which a decision making component 27 can choose the subset of members to make cross-sell offers to, based on his/her return and risk preferences.

In one embodiment, the optimization component 26 applies an integer programming technique to determine the optimal set of solutions. As will be appreciated by those skilled in the art, integer-programming techniques are based on modeling a decision problem (such as, for example, choosing a subset of customers) to maximize an objective function subject to a set of constraints. Examples of integer programming techniques include, but are not limited to, branch-and-bound techniques, genetic algorithms etc.

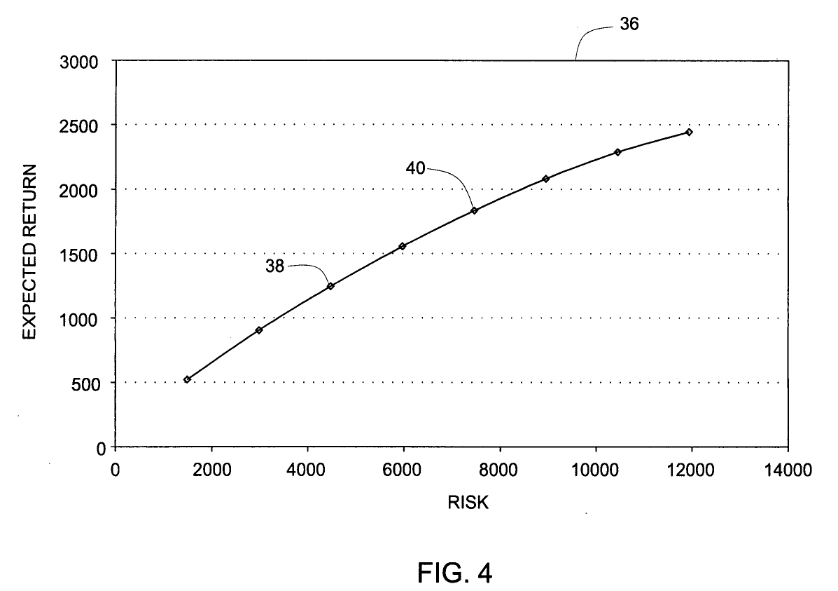

FIG. 4 is a graph illustrating an aggregate expected return and an aggregate risk associated with the acceptance to a cross-sell offer, for one or more subsets of members 38, 40 from the target population 22. A decision-making component 27 may be further coupled to the optimization component 26 to determine a target list of customers from the one or more subsets of members 38, 40 determined by the optimization component 26. In a particular embodiment, the decision-making component 27 determines the target list of customers by maximizing a business measure subject to a set of business constraints. In one embodiment, the business measure is a risk adjusted contributed value (RACV) and the business constraints may include the total amount of credit available for the members of the target population, the total allowable risk level, the minimum expected response level and bounds on the size of the target list of customers.

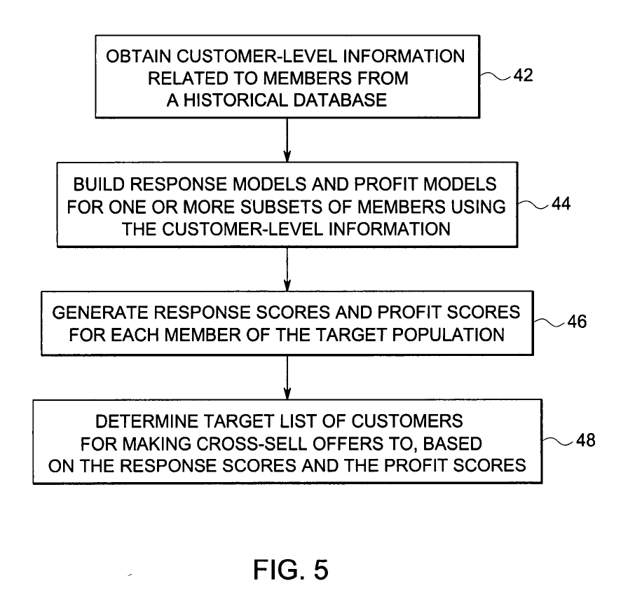

FIG. 5 is a flowchart of exemplary logic, including exemplary steps for selecting a target list of customers for making cross sell offers to, for a financial product. In step 42, customer-level information related to one or more members from a historical database 11 is obtained. As mentioned above, the customer-level information includes demographic data, transaction level data and account level data associated with the one or more members and the financial product includes a financial loan, a credit card or an insurance policy.

In step 44, one or more response models 18 and one or more profit models 19 for one or more subsets of members 16 are built using the customer-level information. As mentioned above, the one or more subsets of members 16 are generated using a re-sampling technique and refer to subsets of random samples of members selected by the model-building component 12. Also, as mentioned above, the response models 18 represent the propensity of response of a member to a given cross-sell offer and the profit models 19 represent a prediction of profitability obtained by a member in response to a given cross-sell offer.

In step 46, one or more response scores and one or more profit scores are generated for one or more members from a target population, using the one or more response models and the one or more profit models. As mentioned above, the target population includes a set of members eligible to be offered a financial product, in a given cross-sell campaign. Also, as mentioned above, the response scores 24 are a measure of a propensity of response by a member from the target population 22, to a given cross-sell offer and the profit scores 25 are a measure of the profit potential obtained by a member of the target population 22, to a given response to a cross-sell offer. In one embodiment, the profit scores 25 represent a set of risk adjusted contributed values for each member from the target population, having an expected return and a corresponding risk.

In step 48, a target list of customers for making cross-sell offers to, are determined, based on the one or more response scores and the one or more profit scores. An optimized aggregate expected return and an optimized aggregate risk associated with the acceptance of a cross-sell offer, for one or more subsets of members from the target population is determined. The target list of customers is then determined based on the optimized aggregate expected return and the optimized aggregate risk for the one or more subsets of members. As mentioned above, the target list of customers is determined based on maximizing a business measure subject to a set of business constraints.

Embodiments of the present invention offer several advantages including the ability to take into consideration customer-level forecast variability in determining estimates of profit potential for one or more members, in response to a cross-sell offer. The disclosed embodiments resolve the variability present in the determination of profit potential for a member, by generating multiple forecasts of profit potential for each member through the use of multiple profit models and repeated re-sampling to data to generate one or more random samples of member subsets. In addition, the disclosed system and method enables the optimization of multiple model outputs, and arrives at multiple solutions to determine a trade-off between expected return and risk for each member in a target list of customers for making cross-sell offers to.

As will be appreciated by those skilled in the art, the embodiments and applications illustrated and described above will typically include or be performed by appropriate executable code in a programmed computer. Such programming will comprise a listing of executable instructions for implementing logical functions. The listing can be embodied in any computer-readable medium for use by or in connection with a computer-based system that can retrieve, process and execute the instructions. Alternatively, some or all of the processing may be performed remotely by additional computing resources based upon raw or partially processed image data.

In the context of the present technique, the computer-readable medium is any means that can contain, store, communicate, propagate, transmit or transport the instructions. The computer readable medium can be an electronic, a magnetic, an optical, an electromagnetic, or an infrared system, apparatus, or device. An illustrative, but non-exhaustive list of computer-readable mediums can include an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer readable medium may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of selecting a target list of customers for making cross sell offers to, for a financial product, the method comprising:
obtaining customer-level information related to one or more members from a historical database;
building one or more response models and one or more profit models for one or more subsets of members, using the customer-level information;
generating one or more response scores and one or more profit scores for one or more members from a target population, using the one or more response models and the one or more profit models; and
determining a target list of customers for making cross-sell offers to, based on the one or more response scores and the one or more profit scores.

2. The method of claim 1, wherein the customer-level information comprises demographic data, transaction level data and account level data associated with the one or more members.

3. The method of claim 1, wherein the financial product comprises a financial loan, a credit card and an insurance policy.

4. The method of claim 1, wherein the one or more subsets of members are generated using a re-sampling technique.

5. The method of claim 1, wherein the response scores are a measure of the propensity of response for each member from the target population, to a given cross-sell offer.

6. The method of claim 1, wherein the profit scores are a measure of the profit potential obtained by a member of the target population, given a response to a cross-sell offer.

7. The method of claim 6, wherein the profit scores represent a set of risk adjusted contributed values for each member from the target population, having an expected return and a corresponding risk.

8. The method of claim 1, further comprising determining an optimized aggregate expected return and an optimized aggregate risk associated with the acceptance of a cross-sell offer, for one or more subsets of members from the target population.

9. The method of claim 8, further comprising determining the target list of customers for making cross-sell offers to, based on the optimized aggregate expected return and the optimized aggregate risk for the one or more subsets of members.

10. The method of claim 9, wherein the target list of customers is determined based on maximizing a business measure subject to a set of business constraints.

11. The method of claim 1, wherein the one or more response models and the one or more profit models are generated using at least one of a regression modeling technique and a neural network modeling technique.

12. A system for selecting a target list of customers for making cross sell offers to, for a financial product, the system comprising:
a model-building component configured to build one or more response models and one or more profit models for one or more subsets of members selected from a model-building population;
a scoring component configured to generate one or more response scores and one or more profit scores for one or more members from a target population, using the one or more response models and the one or more profit models; and
an optimization component configured to determine a target list of customers, for making cross-sell offers to, based on the one or more response scores and the one or more profit scores.

13. The system of claim 12, wherein the model building population comprises customer-level information related to the one or more subsets of members.

14. The system of claim 12, wherein the customer-level information comprises demographic data, transaction level data and account level data related to the one or more subsets of members.

15. The system of claim 12, wherein the financial product comprises a financial loan, a credit card and an insurance policy.

16. The system of claim 12, wherein the one or more subsets of members are generated using a re-sampling technique.

17. The system of claim 12, wherein the response scores are a measure of the propensity of response for each member from the target population, to a given cross-sell offer.

18. The system of claim 12, wherein the profit scores are a measure of the profit potential obtained by a member of the target population, given a response to a cross-sell offer.

19. The system of claim 18, wherein the profit scores represent a set of risk adjusted contributed values for each member from the target population, having an expected return and a corresponding risk.

20. The system of claim 12, wherein the optimization component is configured to determine an optimized aggregate expected return and an optimized aggregate risk associated with the acceptance of a cross-sell offer, for one or more subsets of members from the target population.

21. The system of claim 20, wherein the optimization component is coupled to a decision-making component, and wherein the decision-making component is configured to determine the target list of customers for making cross-sell offers to, based on the optimized aggregate expected return and the optimized aggregate risk for the one or more subsets of members.

22. The system of claim 21, wherein the optimized aggregate expected return and the aggregate risk is determined based on maximizing a business measure subject to a set of business constraints.

23. The system of claim 12, wherein the one or more response models and the one or more profit models are generated using at least one of a regression modeling technique and a neural network modeling technique.

24. A computer readable medium for selecting a target list of customers for making cross sell offers to, for a financial product, the computer instructions comprising:
code for obtaining customer-level information related to one or more members from a historical database;
code for building one or more response models and one or more profit models for one or more subsets of members, using the customer-level information;
code for generating one or more response scores and one or more profit scores for one or more members from a target population, using the one or more response models and the one or more profit models; and
code for determining a target list of customers for making cross-sell offers to, based on the one or more response scores and the one or more profit scores.
